(19) United States
(12) Patent Application Publication
(10) Pub. No.: US 2011/0170069 A1
(43) Pub. Date: Jul. 14, 2011

(54) Stereoscopic film marking and method of use

(76) Inventors: David Lee Lund, Chaska, MN (US); William Gibbens Redmann, Glendale, CA (US); Mark J. Huber, Burbank, CA (US)

(21) Appl. No.: 12/930,564

(22) Filed: Jan. 11, 2011

Related U.S. Application Data
(60) Provisional application No. 61/294,094, filed on Jan. 11, 2010.

(51) Int. Cl. G03B 35/18; G03B 21/32; G03C 11/02

(52) U.S. Cl. 352/43; 352/38; 352/236; 352/60

(57) ABSTRACT

A method and apparatus are described for monitoring frame alignment status and correcting misalignment for film in a stereoscopic 3D projection system, in which gap indicia are provided onto the film in a gap between images, whether the images belong to the same frame or different adjacent frames. Thus, gap indicia are positioned in at least one of an interframe gap and an intraframe gap of the stereoscopic film. During projection of the film, presence or absence of the gap indicia is used to determine a frame alignment status. Frame misalignment is then easily diagnosed and corrected. Characteristics of the gap indicia are modified for improving frame alignment diagnosis.

### CROSS-REFERENCE TO RELATED APPLICATION

The present patent application claims the benefit of priority from U.S. Provisional Patent Application Ser. No. 61/294,094, “Stereoscopic Film Marking and Method of Use”, filed on Jan. 11, 2010. The teachings of the above-identified provisional patent application are expressly incorporated herein by reference in their entirety.

### TECHNICAL FIELD

The present invention relates to projection film and, more particularly, to the use of indicia or other such marks on the projection film for diagnosing frame alignment and misalignment in a stereoscopic projection system.

### BACKGROUND OF THE INVENTION

Well known single-projector 3D film systems use a dual lens arrangement to project simultaneously a left-eye image and a right-eye image from the same strip of film. Generally, the pair of images, which are positioned sequentially above and below each other on the same strip of film, are projected in such a manner that they are substantially superimposed on the viewing screen. Each image pair is projected through various filters in order to separate the projected left-eye image and the right-eye image so that, when an audience member wears glasses having appropriately matched filter in the left and right lens thereof, the left-eye image is seen by the left eye of the audience member and the right eye image is seen by the right eye of the audience member.

Proper image alignment and sequencing of each film image pair in the projector is required to insure that correct alignment and sequencing occurs when the projected image pairs are viewed by the audience member. Improper alignment of these image pairs can result in an unsatisfactory and even unpleasant 3D viewing experience for the audience.

Proper stereoscopic image pair alignment is initially accomplished during the film threading process. Threading 3D film into a projector is a well-known art. When the stereoscopic 3D film is properly threaded and framed so that the left-eye image and the right-eye image of a stereoscopic pair are aligned with the corresponding stereoscopic projection lenses, each image from the stereoscopic image pair is seen through the corresponding viewing lens and eye of the audience member. If the film is mis-threaded and a poor framing is obtained, the left-eye image and the right-eye image may be projected improperly. That is, the left-eye image will be projected through the right-eye lens of the projector, whereas the right-eye image will be projected through the left-eye lens of the projector. This reversal of images results in the projected 3D images appearing pseudoscopic instead of stereoscopic.

Pseudoscopic viewing occurs when the images for one eye are seen by the other eye and vice versa. An image intended for the left eye is seen by the right eye and an image intended for the right eye is seen by the left eye. In pseudoscopic viewing of 3D images, the parallax cues for depth are reversed so that objects, which are supposed to appear beyond or behind the projection screen, appear closer than the projection screen and nearer to the viewing audience member. Similarly, objects, which should properly appear in front of the screen at a distance up to about halfway to the audience member, appear to be beyond or behind the projection screen. Objects that are intended to appear in front of the screen at a distance more than halfway to the audience member cannot be fused because the viewer's eyes must diverge, instead of converge. This divergence results in a wall-eyed viewing condition which can cause confusion, double vision, eye strain, and even physical pain, in certain cases.

When the film is being projected pseudoscopically, the left- and right-eye images being viewed in the same frame pairing are not even members of the same stereoscopic pair. Rather, they are adjacent images from consecutive and, therefore, different stereoscopic pairs. Consecutive stereoscopic image pairs are intended to be 1/24^{th} of a second apart in time, if it is assumed that the images are projected using 24 frames per second presentation mode. During pseudoscopic projection, one of the images in a projected pair will be projected 1/24th of a second later or earlier than it is supposed to be. This misframing results in a noticeable beat between a scene change detected by one eye and the same scene change detected by the other eye.

Ascertaining whether an operating 3D film projection system is projecting the images correctly (stereoscopic) or incorrectly (pseudoscopic) is a difficult task. The burden for achieving proper alignment of the stereoscopic image pairs in projection systems generally falls on the projectionist. Since there are relatively few automated approaches for insuring proper alignment and avoiding pseudoscopic projection, the projectionist must usually view the same images projected for the viewing audience. In order to observe the image projection status, a projectionist must usually:

a) wear glasses in order to see the 3D effect, even if projected incorrectly;

b) look at the same projection screen viewed by the audience;

c) view a scene containing suitably emphatic 3D imagery; and

d) be trained to recognize pseudoscopic projection.

Obviously, not all projectionists are so well trained and perceptive and not all theaters have an adequate staff of such properly trained projectionists. As the number of theaters showing 3D films continues to grow, along with increased numbers of presentation times for each 3D film, this problem continues to grow.

A specialized projection system for detecting pseudoscopic projection of stereoscopic images has been proposed by Lipton in U.S. Pat. No. 5,841,321. In this system, dynamic polarizers are controlled by an indicia imprinted on the edge of the 3D film. When the pseudoscopic condition is sensed from the indicia on the film, the polarizers automatically reverse the polarization supplied to each image of a pair. This approach requires a complete adaptation or replacement of each existing projection system, which may entail inconvenience and increased cost. Certain projection systems may not permit adaptation or retrofitting to accommodate the dynamically controlled polarizer scheme of Lipton. In addition to increasing the cost and burden on the theater, the system proposed by Lipton requires that film producers and distributors adopt and use the specialized indicia on each 3D film print. This operation adds further cost to the 3D experience. Even though Lipton's system reverses the applied polarizations for each image, Lipton does not correct or adjust the misframed condition for the film itself. Since Lipton does not reframe the film in the projection system, the re-polarized images projected by Lipton exhibit the 1/24^{th} of a second temporal mismatch because the film is still misframed.

Thus, the known prior methods and apparatus appear to lack any suitable solutions for overcoming the problems of identifying and controlling the occurrence of a pseudoscopic viewing experience for 3D film projection systems using simple and cost effective means.

### SUMMARY OF THE INVENTION

In accordance with the principles of the present invention, frame alignment for a film in a stereoscopic 3D projection system can be monitored and misalignment corrected by introducing at least first gap indicia onto the film in a gap between images, whether the images belong to the same frame or different adjacent (consecutive) frames. During projection of the film, presence or absence of the first gap indicia is used to determine a frame alignment status. Frame misalignment can then be easily diagnosed and corrected.

In various embodiments, gap indicia are positioned in at least one of an interframe gap and an intraframe gap, i.e., in an interframe gap, or an intraframe gap, or in both types of gaps of the stereoscopic film. Characteristics of the gap indicia are modified for improving alignment diagnosis. In one embodiment, the repetition rate of the gap indicia is adjusted on the film in order to introduce special optical effects for the projected gap indicia.

One embodiment provides a method for use in a three-dimensional (3D) film projection system, the method includes: projecting a film having a plurality of stereoscopic image pairs, the film including a first gap indicium positioned in a first gap between consecutive images in at least a first subset of the plurality of stereoscopic image pairs, in which the first gap is selected from a group including an interframe gap and an intraframe gap; detecting for a presence of at least one of: the first gap indicium and a projection thereof; and determining a stereoscopic frame alignment status for the stereoscopic image pairs based on result of the detection.

Another embodiment provides a method for producing a film, the film comprising a plurality of pairs of stereoscopic images arranged in sequential order, wherein an inter-frame gap is formed between two adjacent images from different consecutive pairs of stereoscopic images, and wherein an intra-frame gap is formed between two adjacent images from a same pair of stereoscopic images, the method includes: writing a first gap indicium to the film within the intra-frame gap, the first gap indicium for identifying a frame alignment condition when the first gap indicium is detected upon being subjected to projection; and writing a second gap indicium to the film within the inter-frame gap, the second gap indicium for identifying a frame misalignment condition when the second gap indicium is detected upon being subjected to projection; in which the second gap indicium exhibits one or more discernibly different properties from the first gap indicium.

Another embodiment provides a film that includes a plurality of stereoscopic image pairs of first and second images arranged in sequential order; a first gap indicium positioned substantially within an intra-frame gap formed between first and second adjacent images from a same stereoscopic image pair; and the first gap indicium for identifying a frame alignment condition when the first gap indicium is detected upon being subjected to projection.

Yet another embodiment provides a projection apparatus, which includes means for projecting a film having a plurality of stereoscopic image pairs, the film including a first gap indicium positioned in a first gap between consecutive images in at least a first subset of the plurality of stereoscopic image pairs, in which the first gap is selected from a group including an interframe gap and an intraframe gap; means for detecting a presence of at least one of: the first gap indicium and a projection thereof. The apparatus also includes at least one of: means for indicating a frame misalignment condition for the stereoscopic image pairs, when the presence is not detected; and means for indicating a frame alignment condition for the stereoscopic image pairs, when the presence of at least one of the first gap indicium and a projection thereof is detected.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, in which:

FIG. 1 is a simplified drawing of a properly framed stereoscopic film projection system using a dual lens and film of the present invention having indicia in the intraframe gap;

FIG. 2 is a simplified drawing of an improperly framed stereoscopic film projection system using a dual lens and film of the present invention having indicia in the intraframe gap;

FIG. 3 depicts 3D film of the present invention having exemplary indicia in the intraframe gap;

FIG. 4 depicts 3D film of the present invention having exemplary indicia in the interframe gap;

FIG. 5 depicts 3D film of the present invention having exemplary indicia in both the intraframe gap and interframe gap;

FIG. 6 shows an exemplary process for using film having indicia in the intraframe gaps;

FIG. 7 shows an exemplary process for using film having indicia in the interframe gaps; and

FIG. 8 shows an alternative exemplary process for using film of the present invention without an aperture plate.

The exemplary embodiments set forth herein illustrate preferred embodiments of the invention, and such exemplary embodiments are not to be construed as limiting the scope of the invention in any manner.

### DETAILED DESCRIPTION

The use of these indicia permits easy identification of proper frame alignment and misalignment for stereoscopic 3D images.

In accordance with the principles of the present invention, a marker is placed at a particular location on stereoscopic 3D film so that, when the film images are projected, the projectionist or an automated detection system can easily determine the stereoscopic or pseudoscopic status of the projection. This inventive approach avoids the need for a projectionist to wear specialized 3D glasses, to look at the viewing screen, or to have extensive training for detecting a pseudoscopic presentation. Furthermore, it avoids the need for the film to include scenes having suitably emphatic 3D imagery. Details of one or more implementations are set forth herein and in the accompanying drawings. Even if described in one particular manner, it should be clear that implementations may be configured or embodied in various manners. For example, an implementation may be performed as a method, or embodied as an apparatus configured to perform a set of operations, or embodied as an apparatus storing instructions for performing a set of operations.

Existing 3D projection systems use a single standard 2D film projector having a dual lens system to project simultaneously each of two images from a stereoscopic pair—one image is projected for the left eye and the other is projected for the right eye. Inline filtering for each of the left- and right-eye halves of the dual lens—typically the bottom and top lenses, respectively—in the projection system encodes the corresponding left- and right-eye images of a stereoscopic pair. When the encoded image pair is projected onto a theater screen, audience members wearing glasses that included appropriate, properly oriented filters corresponding to those of the dual lens system, will perceive the left-eye image in their left eyes, and the right-eye image in their right eyes.

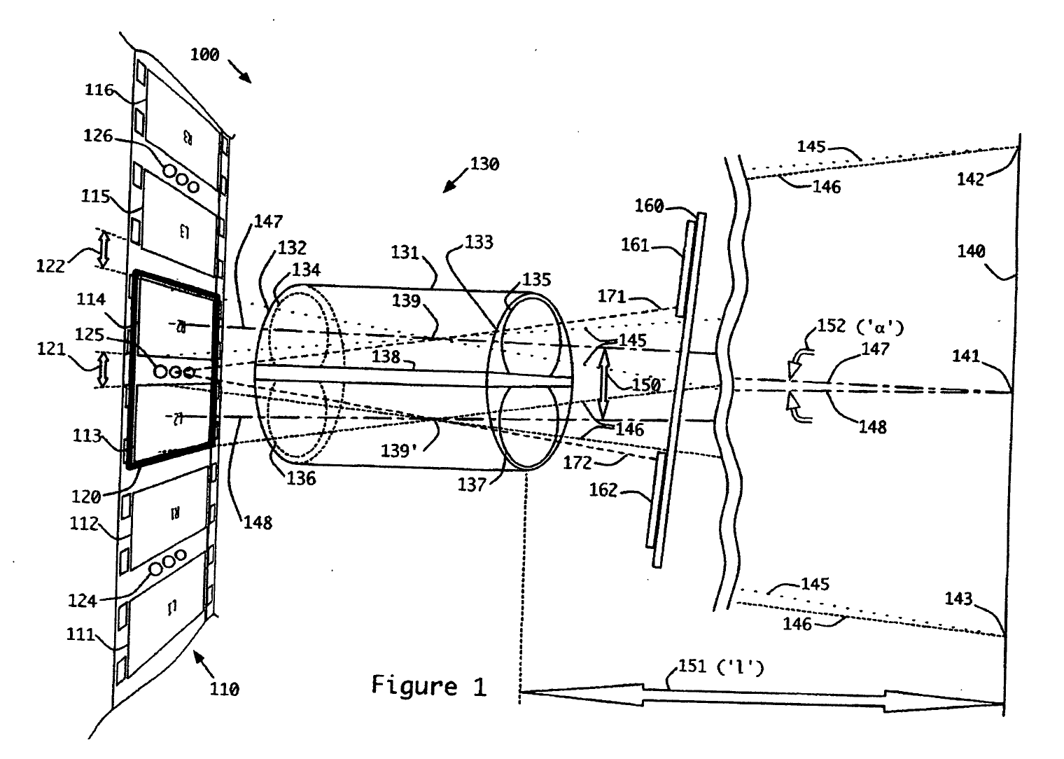

FIG. 1 shows an over-under lens 3D film projection system 100, also called a dual-lens 3D film projection system or projector. Rectangular left-eye image 113 (L2) and rectangular right-eye image 114 (R2), both on 3D film 110 and shown as being properly framed in the aperture plate, are simultaneously illuminated by a light source and condenser optics (not shown in the figure), collectively called an illuminator, which is located behind the film while framed by aperture plate 120 such that all other images on film 110 are not visible because these images are covered or otherwise obscured by the opaque portion of the aperture plate. It will be apparent to persons skilled in this art that primarily the inner edge of the aperture is illustrated in this figure for clarity purposes. The left- and right-eye images, which together form a stereoscopic image pair and are visible through aperture plate 120, are projected by over-under lens system 130 through port glass 160 onto screen 140 where the images are generally aligned and superimposed on each other such that the tops of both projected images are aligned at the top edge 142 of the screen viewing area, and the bottoms of the projected images are aligned at the bottom edge 143 of the screen viewing area.

Film projector 100, which is depicted not to scale, includes an illuminator which usually includes a high intensity lamp such as an arc lamp having envelope, at the center of which is a luminous arc. An elliptically shaped reflector can be used in the projector for reflecting light rays from the luminous arc near the first focal point of the ellipse to form an image of the arc near the second focal point of the ellipse. In most film projectors, the image of the luminous arc is formed at or near the film gate, which is depicted as an aperture cut into an aperture plate. This aperture is depicted in FIG. 1 as an opening for which only the boundary of the opening in the aperture plate is shown. In this way, the illumination from the luminous arc is provided as a smooth field, providing adequate illumination over the entirety of the opening for the aperture of aperture plate 120. It should be noted that element 120 may be referenced herein interchangeably by the terms “aperture” and “aperture plate” without any confusion, limitation, or loss of generality.

Stereoscopic film 110 comprises a film substrate having a row of perforations along each edge. The perforations allow for engagement by a sprocket or other such mechanism (none shown) to advance the film smoothly and continuously from one image to the next. As mentioned above, the images on film 110 are grouped in pairs of left and right images. Stereoscopic image pairs (R1, L1), (R2, L2), and (R3, L3) as shown in FIG. 1 are sequential and consecutive image pairs provided along film 110. For example, the stereoscopic image pair including images R2 and L2 corresponds to a right-eye image 114 and left-eye image 113, respectively. Both images from a stereoscopic image pair are simultaneously illuminated while within the opening formed by aperture of aperture plate 120. Images in the same stereoscopic pair such as images 114 (R2) and 133 (L2) are separated from each other by a gap defined as intra-frame gap 121. Consecutive stereoscopic image pairs, or two adjacent images (e.g., left- and right-eye images) belonging to different stereoscopic image pairs, are separated from each other by a gap defined as inter-frame gap 122. Inter-frame gap 122 may or may not exhibit the same dimensions as intra-frame gap 121. Due to the inverting nature of the projector system 100, the images on the film are provided in the projector in an inverted manner such that each image will be shown in its upright or erect orientation when projected on the screen.

Other stereoscopic pairs are shown in FIG. 1, with images 111 and 112 forming the first stereoscopic pair (L1, R1), and images 115 and 116 forming the third stereoscopic pair (L3, R3).

Lens system 130 comprises lens body 131 having an entrance end 132 and an exit end 133. Entrance end 132 faces film 110 and exit end 133 faces screen 140. In this embodiment, lens system 130 is a stereoscopic dual lens having an upper portion for projecting right-eye images and a lower portion for projecting left-eye images. The upper portion of lens system 130 includes entrance lens element 134 on the film side and exit lens element 135 on the screen side. The lower portion of the lens system includes entrance lens element 136 on the film side and exit lens element 137 on the screen side. Upper and lower portions of lens system 130 are separated by septum 138. Septum 138 is used to prevent leakage of light between the upper and lower portions of the lens system. In certain cases, septum 138 can be embodied as a gap that is controllably adjustable by an adjustment element to have a variable gap width that can be expanded or contracted. For this latter embodiment, the gap is lined with a coating or the like to prevent leakage of light between the upper and lower portions of the lens system.

Additional lens elements may be included in the projection system. For example a magnifier (not shown) following the exit end of dual lens 130 may also be added, when appropriate in order to facilitate proper adjustment of the projection system 100.

Projection screen 140 has viewing area delineated by a top 142 and bottom 143. In the center portion of screen 140 lies center point 141 at which the projection of film images 113 and 114 should ideally be centered. When properly aligned, the projections of right-eye image 114 and left-eye image 113 are substantially superimposed on screen 140. Both projected images have their respective centers substantially co-located at screen center 141, as represented in FIG. 1 by the convergence of the center rays 147 and 148 (long/short dashed centerlines) onto point 141. Upon projection, the tops of images 114 and 113 are both imaged substantially along top 142 of screen 140, and the bottom of images 114 and 113 are both projected substantially along bottom 143 of screen 140.

In a properly-adjusted projection system 100, center ray 147 associated with the center of image 114 propagates through the center of corresponding aperture stop 139 to screen center 141. Likewise, center ray 148 associated with the center of image 113 propagates through the center of corresponding aperture stop 139′ to screen center 141. Center rays 147 and 148 form convergence angle 152, also shown as α. The convergence angle α corresponds to double the arctangent of half of interlens distance 150 (shown as distance d) divided by throw distance 151 (shown as distance l). The top and bottom of projected image 114 are represented by rays 145, whereas the top and bottom of projected image 113 are represented by rays 146. When properly aligned, the top and bottom rays of the two projected images substantially converge with each other, aligned with the screen top edge 142 and screen bottom edge 143.

When polarizing components, such as linear or circular polarizers, are employed in the projection system, it is expected that screen 140 should exhibit a polarization preserving property. One such polarization preserving type of screen is a silver screen. On the other hand, when polarizing components are not employed in the system, screen 140 may be realized without the need for a polarization preserving property. For the example described herein, it is preferred that the screen exhibit a polarization preserving property.

The lens system 130 generally includes a filter module for encoding the images. This filter module can include one or more of any of linear or circular polarizers or other non-polarizing filter elements, such as red/blue filters for anaglyphic 3D or multi-band interference filters, all of which are well known in the art and are suitable for separating the right- and left-eye images so that an audience member can perceive a stereoscopic 3D presentation.

In projection system 100, each of the left- and right-eye images 113 and 114 are projected through left- and right-eye encoder filters, respectively. The encoder filters, which are also known as projection filters, are not depicted in this figure. In order to decode the encoded images properly, each audience member is provided with a pair of 3D glasses (not shown) to wear, such that the right eye of each audience member is looking through a right-eye decoder filter while the left eye is looking through a left-eye decoder filter. The decoder filter is also known as a viewing filter. The pair of left-eye encoder and decoder filters is selected to allow the left eye to view the projection of left-eye image 113 on screen 140. This pair does not allow the left eye to view the projection of right-eye image 114. Similarly, the pair of right-eye encoding and decoding filters is selected to allow the right eye to see only the projection of right-eye image 114 on screen 140, without seeing any part of left-eye image 113.

In the present embodiment, circular polarization is employed for the exemplary encoder and decoder filters. When the right-eye encoding filter employs a right-handed circular polarizer, the projection of right-eye image 114 is right-handed (or clockwise) circularly polarized before reflecting from screen 140. As mentioned above, projection screen 140 must preserve the polarization of the image when polarization-based encoding filters, whether linear or circular polarization type, are used. After reflection from screen 140, the circular polarization of the projected image is reversed in the same manner as if the image had reflected off a mirror. When viewed by an audience member, the projection of the right-eye image 114 will reflect from the screen and become circularly polarized in a left-handed or counterclockwise manner. For this reason, an appropriate selection for the right-eye decoder filter is a left-handed (counterclockwise) circular polarizer, which would pass the reflected projection of the right-eye image 114 from the screen 140 to the right-eye of an audience member.

When the left-eye encoding filter employs a left-handed circular polarizer, the projection of left-eye image 113 is left-handed (or counterclockwise) circularly polarized before reflecting from screen 140. After reflection from screen 140, the circular polarization of the projected image is reversed in the same manner as if the image had reflected off a mirror. When viewed by an audience member, the projection of the left-eye image 113 will reflect from the screen and become circularly polarized in a right-handed or clockwise manner. For this reason, an appropriate selection for the left-eye decoder filter is a right-handed (clockwise) circular polarizer, which would pass the reflected projection of the left-eye image 113 from the screen 140 to the left-eye of an audience member.

The right-eye image 114 is not viewable, in this example, by the left eye since the projected and reflected right image 114 exhibits left-handed circularly polarization and the left-eye decoder filter employs a right-handed circular polarizer. Similarly, the left-eye image 113 is not viewable, in this example, by the right eye since the projected and reflected left image 113 exhibits right-handed circular polarization and the right-eye decoder filter employs a left-handed circular polarizer. Unless the polarization orientation of the reflected image matches the polarization orientation of the decoder filter for a particular eye lens in the 3D glasses, that image will be blocked from the viewer's vision for the particular eye.

Other combinations for encoder filters and decoder filters are known in the art and can be employed herein. These combinations can include linear polarizers and interference comb filters and the like.

In the description herein, various terms may be used to explain the marks placed on the film in accordance with the principles of the present invention. These terms may include “mark(s)”, “indicium”, “indicia”, “tick mark(s)”, “warning mark(s)”, “indicating mark(s)”, “indicator mark(s)”, and the like. The use of any or all of these terms and other similar terms is intended to convey the same meaning without limitation or modification, unless expressly stated to the contrary.

In accordance with the principles of the present invention, stereoscopic film 110 includes intraframe gap indicia 124, 125, 126 located within each intraframe gap. For example, indicium 125 is located in intraframe gap 121. Each indicium in any gap may have any number of components, with various combinations of size(s), color(s), shape(s), and/or position(s). Moreover, each indicium does not have to use similar components throughout the indicium, and one indicium may be different from the next indicium or from other indicia. In one exemplary embodiment, intraframe gap indicia 124, 125, 126 are formed as a row of green dots. As mentioned above, other embodiments of the indicia may include additional or different text, lines, patterns, colors, icons, and the like. Psychological or human factor-based characteristics may also be employed for these indicia. For example, green dots may indicate a satisfactory alignment, whereas red dots may indicate an incorrect alignment.

In an alternative exemplary embodiment, consecutive intraframe gap indicia (i.e., indicia present in consecutive intraframe gaps) may differ from one another in order to have the projected intraframe gap indicia appear animated or flashing, when the projector is running. Animation may include the effect of chasing lights so that the light pattern would appear to move from right to left or left to right and the like. Flashing light pattern may be realized by alternately inserting and omitting intraframe gap indicia at a number of consecutive intraframe gaps. The number of intraframe gaps employed in such a realization will affect the blink rate of the flashing light pattern. For example, a 2 Hz blink rate can be realized by providing indicia in six consecutive intraframe gaps, followed by an omission of indicia in the next six consecutive intraframe gaps, and so on. Other patterns and effects may be realized by variations of the embodiments described above.

In a properly adjusted projection system 100, images 113 (L2) and 114 (R2) of a stereoscopic pair appear through the opening in aperture plate 120. This pair of images is then projected in focus onto screen 140 through the respective lower and upper halves of dual lens 130. In addition, some or all of intraframe gap 121 is projected through each of the upper and lower halves of dual lens 130.

Port glass 160 is provided with suitable masking to mask the screen projection of film images outside the actual left-eye and right-eye images. Masking is provided by upper mask 161 and lower mask 162, which block the projection of one eye's image by the half of the lens intended for the other eye's image and vice versa. For example, upper mask 161 is used to prevent any stray projection of left-eye image 113 by the upper half of lens 130 from reaching the screen. It should be understood that, without mask 161, at least a portion of image 113 could be projected above the top edge 142 of screen. Similarly, lower mask 162 blocks any stray projection of right-eye image 114 from being projected below bottom of screen 143 through lower half of lens 130. In addition, upper port mask 161 prevents projection of a substantial portion of intraframe gap 121 above screen 140, whereas lower port mask 162 prevents projection of a substantial portion of intraframe gap 121 below screen 140. Thus, these upper and lower projections of intraframe gap 121 are substantially intercepted and blocked by upper and lower port masking 161 and 162.

When intraframe gap indicium 125 is in the correct position within the aperture plate, as shown in FIG. 1, the same illumination source projecting through images 113 and 114 also illuminates indicia 125. This results in a projection of indicium 125 through each of the upper and lower halves of dual lens 130. Exemplary center ray 171 from the center of indicium 125 propagates through aperture stop 139 of the upper half of lens 130 and intersects upper port mask 161. Similarly, center ray 172 from the center of indicia 125 propagates through aperture stop 139′ of the lower half of lens 130 and intersects lower port mask 162. In this way, an image of intraframe gap indicium 125 appears to be projected (though not necessarily in focus) on both upper and lower port masks 161 and 162. It should be recalled that this result is achieved when intraframe gap 121 is correctly positioned in the aperture plate, which occurs when 3D projection system 100 is properly framed.

Visualization of the projected intraframe indicia allows the projectionist to determine whether or not stereoscopic film 110 is correctly framed. When the intraframe indicia are visible on the port glass masks, then the film is considered to be properly framed for stereoscopic viewing. When the intraframe indicia are not visible on the port glass masks, then the film is considered to be not properly framed for stereoscopic viewing and the viewing condition is pseudoscopic. In the exemplary embodiment in which intraframe gap indicium 125 comprises green dots, the green dots are projected and appear above and below the opening between the port glass masks 161 and 162—that is, projected onto the masks 161 and 162—but blocked by the masks from projection onto screen 140. In this example, visualization of the presence or absence of the green dot pattern give a projectionist a clear signal (e.g., green-light) that the stereoscopic film 110 is correctly framed for presentation. This visualization is can be performed by a projectionist without any need to wear specialized 3D glasses, to look at the viewing screen, or to have extensive training for detecting a pseudoscopic presentation. Furthermore, there is no need for the film to include scenes having suitably emphatic 3D imagery.

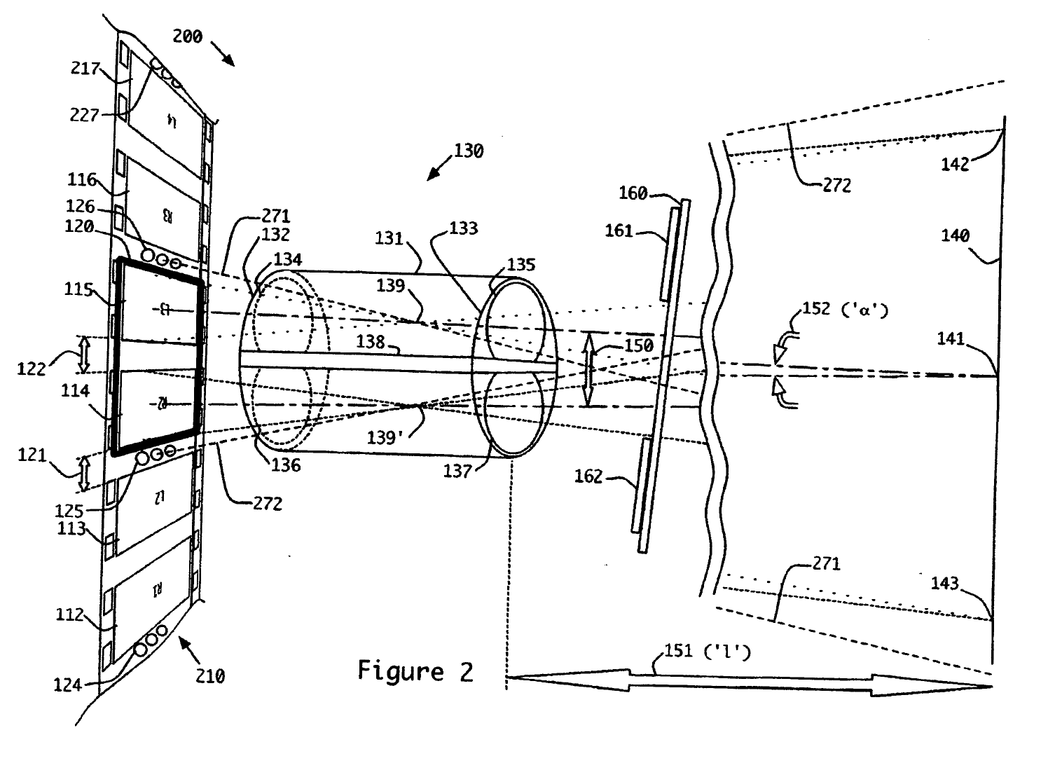

FIG. 2 shows a projection system 200 similar to projection system 100, as described above. Elements shown in FIG. 2 that are similar or identical to those in FIG. 1 are identified with similar reference numerals. For the system 200, the film is depicted in a condition of incorrect framing, which would lead to pseudoscopic viewing. Film 210 is shown as being advanced by one-half frame relative to film 110, i.e., advanced by an additional one half of a stereoscopic pair—typically two perforations—past the framing position for film 110. Due to the half pair advance of the film, image 111 (L1 at the bottom of FIG. 1) is no longer depicted and now, left-eye image 217 (L4) from the fourth stereoscopic image pair (L4, R4) is visible. Also, the intraframe gap indicium 227, which is positioned in the intraframe gap of the fourth image pair, is now visible on film 210.

Due to the incorrect framing of film 210, the two images in the aperture are from different pairs. Right-eye image 114 (R2) is now shown in the lower part of the aperture plate whereas left-eye image 115 (L2) is shown in the upper part of the aperture plate. Right-eye image 114 is part of the second image pair and left-eye image 115 is part of the third image pair. When projected, images 114 and 115 (R2 and L3) converge on the screen 140 in a way substantially similar to that for images 113 and 114 (L2 and R2), as described in reference to FIG. 1. However, images 114 and 115 (R2 and L3) belong to separate and or different stereoscopic image pairs. The images are presented in position for the opposite eye of the viewer. In other words, the right-eye image 114 (R2) is positioned for display to the viewer's left eye, and left-eye image 115 (L3) is positioned for display to the viewer's right eye. For completeness, it should be noticed that the gap appearing through the horizontal middle of the opening in aperture plate 120 is inter-frame gap 122, not intra-frame gap 121 as shown in FIG. 1.

In this example, intraframe gap indicia 125 and 126 are behind, and therefore blocked by, the opaque portion of aperture plate 120. As a result, the intraframe gap indicia cannot be projected when the film is misframed as shown in FIG. 2. Since the indicia are blocked, port glass masks 161 and 162 do not receive projected images of any intraframe gap indicia. Thus, for the exemplary embodiment discussed above having green dots as intraframe gap indicia, the green dots are not visible on the port glass masks because the system cannot project them.

While it is preferable to utilize the aperture plate and the port glass masks in the system, it is possible that one or both of these elements may be removed or omitted. When aperture plate 120 is removed and with reference to FIG. 2, intraframe gap indicia 125 can be projected through the lower half of lens 130 as shown by central ray 272. Central ray 272 propagates through the center of lower aperture stop 139′. This ray is not blocked by any port glass masking since it passes in the region between the port masks. Thus, ray 272 will be projected—substantially in focus—above the screen top 142. Similarly, intraframe gap indicium 126 will be projected through the upper half of lens 130 as shown by central ray 271, passing through the center of upper aperture stop 139. Likewise, ray 271 is not blocked by any port glass masking and thus will be projected below the screen bottom 143.

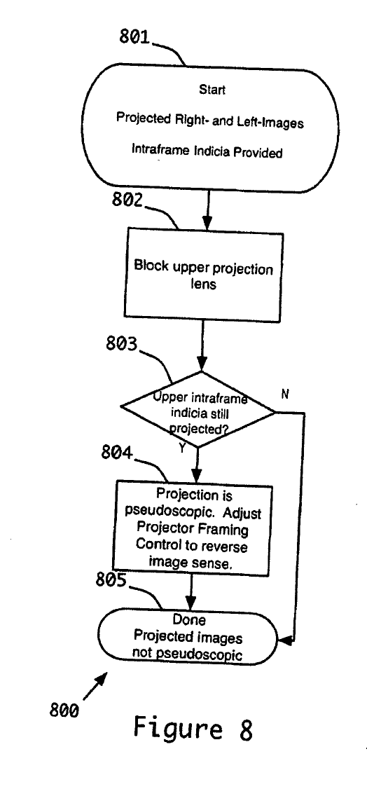

If both port glass masks 161 and 162 and aperture plate 120 were eliminated from the projection system for some reason, the projection of correctly framed film 110 and incorrectly framed film 210 would produce images of intraframe indicia at the screen 140. A procedure for distinguishing between the projection of a correctly framed film versus an incorrectly framed film is described below in conjunction with FIG. 8.

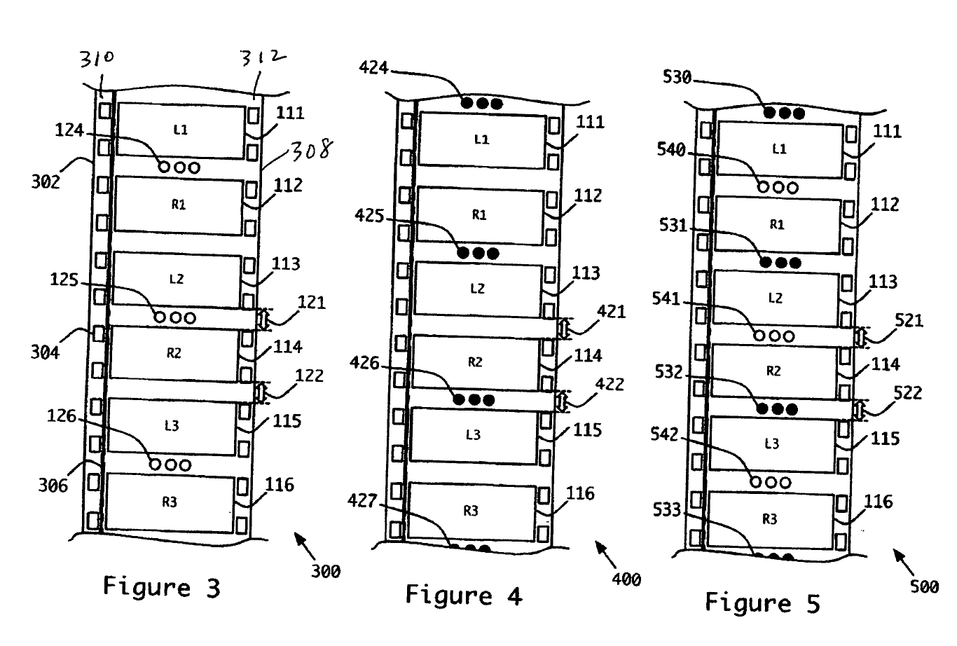

FIG. 3 shows an embodiment of stereoscopic film 300 including intraframe gap indicia realized in accordance with the principles of the present invention. Film 300 is suitable for use in the embodiments of film 110 and 210 shown in FIGS. 1 and 2. In intraframe gap 121 and interframe gap 122, for example, intraframe gap indicium 125 and interframe gap indicium 126, respectively, are provided.

Film print 300, also known as film stock, has a number of stereoscopic image pairs arranged in an uninterrupted sequence of alternating right- and left-images. Right- and left-eye images 114 and 113, respectively, of the same stereoscopic pair (R2, L2) are representative images in the film reel. Right-eye image 114 and left-eye image 113 are each bounded by a respective frame boundary. This frame boundary, in turn, defines a maximum extent for a corresponding projected image. In one example, this frame boundary corresponds to the maximum extent of an image having a standard width (W) of 0.825″ on the film, based on a well known film format. It should be appreciated that the distinct frame boundaries shown in the figures (e.g., FIGS. 1-5) are not generally present or actually visible on the film. Instead, each rectangle can be considered as a virtual geometric entity to assist in the definition and understanding of image and non-image areas on the film. The size of the rectangular area is usually set by standard or convention. Regions inside the frame boundaries are considered as image areas, and generally contain image content.

Actual dimensions for each frame boundary are typically determined in accordance with the format selected for the stereoscopic presentation. In one exemplary embodiment, the dimensions for a standard 35 mm film run a four-perforation inter-frame height of 0.748 inches. The height of a stereoscopic image can be determined as half of the inter-frame height less half the sum of the intra-frame gap 121 and inter-frame gap 122. With a 0.825″ maximum image width and an aspect ratio of 2.39:1 (scope) for each image, the image height will be about 0.345″. For a symmetric frame gap configuration, in which the inter-frame gap equals the intra-frame gap, the gap distance will be approximately 0.029″. Clearly, these gap dimensions will be different for an asymmetric gap configuration. In other embodiments that are based on different film formats or standards, different dimensions may apply. It should be understood that the principles of the present invention apply equally to all known film formats or standards and to both asymmetric and symmetric gap configurations.

Outer edges beyond the frame boundaries represent the expected extent of the camera aperture and generally delineate that portion of film print 300 corresponding to the portion of a film negative that would be exposed by a camera or a film recorder. Outer edges are not generally marked on the film but are virtual geometric entities with dimensions and layout that are governed in practice by standards and industry conventions. Ancillary information may be introduced onto the film in at least one of the left and right peripheral regions 310, 312 (i.e., between the respective left and right sides of frame boundaries and the corresponding left and right edges 302, 308 of the film stock). For example, analog optical sound tracks 306 can be placed on the film in the left peripheral region 310, as shown in FIG. 3. Similarly, digital optical sound tracks (not shown), such as an inter-perforation sound track and an extra-perforation digital sound track, can be positioned on the film in at least one of the peripheral regions. Perforations 304 are also formed on the film in the peripheral regions 310, 312.

While our description has so far been focused on the use of intraframe gap indicia, it is contemplated that interframe gap indicia may be used alone or in conjunction with the aforementioned intraframe gap indicia. FIG. 4 shows an alternative embodiment realized in accordance with the principles of the present invention in which stereoscopic film 400 includes interframe gap indicia 424, 425, 426 and 427. Each interframe gap indicium is positioned within its corresponding interframe gap, such as interframe gap 422 including interframe gap indicium 426. As described above, the interframe gap is a region of separation between adjacent or consecutive stereoscopic image pairs. Interframe gap 422 is shown between stereoscopic image pair (L3, R3) and stereoscopic image pair (L2, R2). In this exemplary embodiment, intraframe gaps indicia have not been included.

In an exemplary embodiment, consistent with the depiction shown in FIG. 4, the interframe gap indicia 424-427 are realized as red dots. The use of this type of indicia results in a converse sense of operation to the scenario in which green dots are used as intraframe gap indicia. In other words, a properly framed presentation in a projection system having both the aperture plate 120 and port masks 161 and 162 installed will not result in projection of any indicia on port masking 161 and 162, because the projection of red dots from the interframe gap indicia is blocked by aperture plate 120. In this case, a properly framed stereoscopic film would result in the absence of any projected interframe gap indicia. It may be recalled that a similar blocking result occurred for the intraframe gap indicia 125 and 126 in FIG. 2 (i.e., absence of a projected intraframe gap indicia), when the frame was misaligned.

In contrast, when the presentation of film 400 is improperly framed and thereby operating in the undesirable pseudoscopic mode, one of interframe gap indicia 424-427 would be located at the horizontal center of the opening in aperture plate 120. Thus, the red dots of the one interframe gap indicia would be projected onto upper and lower port masking 161 and 162. The projection of red dots from the interframe gap indicia onto the viewing screen is now blocked by the installed port masks. Again, it may be recalled that a similar result occurred for the intraframe gap indicia 125 in FIG. 1 and FIG. 3, when the frame was properly aligned.

When the exemplary red dots are employed for interframe gap indicia 424-427, improper framing will result in the appearance of red dots on upper and lower port glass masks 161 and 162 to serve as an indicator or warning to a projectionist that the film is misaligned and that the system status is in need of correction or attention. For this example, when red dots do not appear on the upper and lower port glass masks 161 and 162 (i.e., the red dots are not present), this condition or state of projection serves as an indicator to a projectionist that the film is properly aligned and that the system status is not in need of correction or attention at this time.

FIG. 5 shows another exemplary embodiment realized in accordance with the principles of this invention, featuring a combined use of intraframe gap indicators and interframe gap indicators in the stereoscopic film 500. Film 500 includes both interframe gap indicia 530, 531, 532 and 533, as well as intraframe gap indicia 540, 541 and 542. For example, intraframe gap 521 is marked by intraframe gap indicia 541 and interframe gap 522 is marked by interframe gap indicia 532.

When intraframe gap indicia 540, 541 and 542 are realized as green dots and interframe gap indicia 530, 531, 532 and 533 are realized as red dots, green dots will be projected onto port glass masks 161 and 162 when the 3D film in the projection system is properly framed. However, when the film in the projection system is not properly framed, red dots will be projected onto the port glass masks. In other words, the combined use of interframe and intraframe gap indicia gives a positive and visible response that the system is either properly framed or misframed. In contrast, the use of one or the other of these gap indicia will result in a positive and visible response for one alignment condition, while the other alignment condition is discerned solely by the absence of any positive and visible response. The example of FIG. 5 shows that intraframe and interframe indicia are provided within the same subset of stereoscopic image pairs (L1, R1), (L2, R2) and (L3, R3). In other examples, interframe indicia can be provided for a first subset of stereoscopic image pairs, and intraframe indicia provided for a second subset of image stereoscopic pairs that are different from the first subset.

Various other combinations and modifications are contemplated for the gap indicia. For example, when the red dots are positioned to appear in six consecutive interframe gaps, and then are absent or omitted from the next six consecutive interframe gaps, the projected red dot images impinging on the port glass masks appear to blink at approximately a rate of 2 Hz (Hertz), when the projection system is not properly framed. Thus, by casual inspection and without the need for 3D glasses or special training, a projectionist can observe an image of constant green dots, when the projection system is correctly framed for stereoscopic viewing, or blinking red dots, when the projection system is incorrectly framed resulting in pseudoscopic viewing.

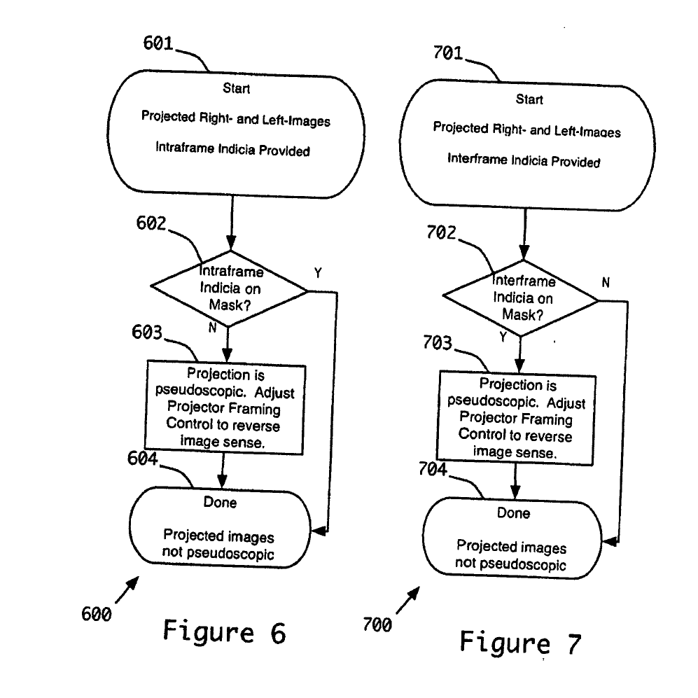

FIG. 6 illustrates a process 600 for verifying and correcting, if necessary, the framing alignment status of a 3D film projection system using intraframe gap indicia. In step 601, left- and right-eye images from 3D film such as film 300, which includes intraframe gap indicia, are projected on the screen, e.g., with the left- and right-eye images centered with respect to the screen, as described above. For this example, it is assumed that aperture plate 120 is installed. Operation without the aperture plate and/or the port glass masks can also be performed with the viewing and observation modifications mentioned above.

In step 602, while the images are projected, it is determined whether the intraframe indicia are being projected onto or visible on the port glass masks. If the intraframe gap indicia are projected onto the port glass masks, it is then determined that the images are properly framed and that the stereoscopic film in the projection system is aligned correctly. At this point, the process ends at step 604 because the system is projecting images in the proper stereoscopic, i.e., non-pseudoscopic, projection mode. If in step 602, no intraframe indicia are projected onto the port glass masks, it is then determined that the images are improperly framed and that the stereoscopic film in the projection system is misaligned, i.e., frame misalignment condition. In this case, the system is projecting images in an improper pseudoscopic or non-stereoscopic projection mode and correction or adjustment should be commenced to return the system to the desired stereoscopic or non-pseudoscopic projection mode. The process passes control to step 603.

In step 603, the projection framing is adjusted to reverse the image sense so that the projection is changed from a pseudoscopic mode to a non-pseudoscopic (stereoscopic) mode. Typically, this adjustment can be performed by the projectionist by manually advancing or retarding the film in the gate (at the opening of aperture plate 120) by two perforations to achieve proper framing. At this point, the process ends at step 604 since proper framing of the images has been realized.

One or both of steps 602 and 603 can be performed automatically, i.e., in an automated manner, instead of manually by projectionists or the like. For example, one or more automated sensors or detectors (e.g., electronic devices suitable for image, pattern and/or color detection) can be provided in step 602 to view the images and detect a certain state of projection or condition for the projected intraframe gap indicia. Furthermore, instead of viewing the projected images like a projectionist, it is also possible to determine the framing status by using the sensors to view directly whether or not the intraframe gap indicia appears at the film gate or other location along the intermittent film path (e.g., one or more sensors is used for detecting a presence or appearance of the indicia at the film gate). This approach would also eliminate the need to actually project the indicia images. If framing adjustment is determined to be necessary in step 603, one or more processors operatively coupled to the sensor can automatically control a framing controller to automatically adjust the framing according to the results obtained from the sensor. While one or more sensors/detectors can be employed for determining the presence or absence of gap indicia, pattern recognition software together with other programmed instructions consistent with the process can be carried out by one or more processors coupled to appropriate framing controller in the projection system.

FIG. 7 illustrates a process 700 for verifying and correcting, if necessary, the framing alignment status of a 3D film projection system using interframe gap indicia. In step 701, left- and right-eye images from 3D film such as film 400, which includes interframe gap indicia, are projected on the screen, e.g., with the left- and right-eye images centered with respect to the screen, as described above. For this example, it is again assumed that aperture plate 120 is installed. Operation without the aperture plate and/or the port glass masks can also be performed with the viewing and observation modifications mentioned above.

In step 702, while the images are projected, it is determined whether the interframe indicia are being projected onto or visible on the port glass masks. If the interframe gap indicia are not projected onto the port glass masks, it is then determined that the images are properly framed and that the stereoscopic film in the projection system is aligned correctly. At this point, the process ends at step 704 because the system is projecting images in the proper stereoscopic, i.e., non-pseudoscopic, projection mode. If in step 702, interframe indicia are projected onto the port glass masks, it is then determined that the images are improperly framed and that the stereoscopic film is misaligned, i.e., frame misalignment condition. In this case, the system is projecting images in an improper pseudoscopic or non-stereoscopic projection mode and correction or adjustment should be commenced to return the system to the desired stereoscopic or non-pseudoscopic projection mode. The process passes control to step 703.

In step 703, the projection framing is adjusted to reverse the image sense so that the projection is changed from a pseudoscopic mode to a non-pseudoscopic (stereoscopic) mode. Typically, this adjustment can be performed by the projectionist by manually by advancing or retarding the film in the gate (at the opening of aperture plate 120) by two perforations to achieve proper framing. At this point, the process ends at step 704 since proper framing of the images has been realized.

As mentioned above, one or both of steps 702 and 703 can be performed automatically, i.e., in an automated manner, instead of manually by projectionists or the like. Such automation can be achieved through the use of sensors or detectors and one or more processors coupled to a framing controller to determine framing misalignment via sensing the presence or absence of gap indicia and then responsively performing whatever automatic controlled adjustment is required.

It will be understood that either or both of procedures 600 and 700 can also be used successfully with film 500, which includes both intraframe and interframe gap indicia.

FIG. 8 shows a process 800 for verifying and correcting, if necessary, the framing alignment status of a 3D film projection system similar to dual-lens system 100 in cases when the aperture plate 120 is not present in the system. When the aperture plate is missing or omitted from the system, projections of intraframe or interframe gap indicia will be visible at all times, regardless of whether the framing is correctly or incorrectly aligned. The process is suitable for detecting framing alignment errors.

In step 801, left- and right-eye images from 3D film such as film 300, which includes intraframe gap indicia, are projected on the screen (e.g., centered on the screen) by the system without aperture plate 120 installed. In step 802, the upper projection lens is blocked to prevent images from being projected through this lens. Blocking can be performed either manually or automatically. For manual blocking, the projectionist can simply cover the upper exit lens 135 with a hand or a card (neither shown). For automated blocking, the projection system can be configured with associated processor(s) to execute instructions causing an opaque component or beam block to be inserted into the upper projection optical path.

In step 803, while the images are projected, it is determined whether the intraframe gap indicia—now projected only by the lower projection lens—are projected onto the upper port glass masking 161 and/or above the projection screen 140. The latter case occurs when the gap indicia are projected by lower lens along central ray 272, as shown in FIG. 2. If it is determined that no intraframe gap indicia images are present in the locations mentioned above, then it is concluded that the images are properly framed and that the stereoscopic film in the projection system is correctly aligned. At this point, the process ends at step 805 since the system is operating in a proper stereoscopic (non-pseudoscopic) projection mode.

If in step 803, it is determined that the upper intraframe indicia are still projected onto the upper port glass mask 161 or above screen 140, then it is concluded that the projection is currently in a pseudoscopic mode. In this case, the intraframe gap indicia are projected by the lower lens along central ray 272. Control is then transferred to step 804.

In step 804, projection framing is adjusted to reverse the image sense. Either manual or automated framing adjustments can be performed as described above.

In another embodiment, process 800 can be modified for determining frame alignment status for a 3D film by monitoring interframe gap indicia (e.g., film 400) by reversing the sense of the decision in step 803. Thus, with the upper lens and its upper projection optical path blocked, the projection status is determined to be stereoscopic, i.e., a stereoscopic frame alignment condition, when the interframe gap indicia (e.g., located below the aperture plate, occupying the position shown for indicia 125 in FIG. 2) are still projected on upper port mask 161 and/or above screen 140. In this case, the interframe gap indicia are projected by the lower lens along a central ray direction similar to that of ray 272 for the intraframe indicia in FIG. 2. But if the interframe gap indicia are determined to be not visible or projected on the upper port mask 161 or above screen 140, then the current projection mode is determined to be pseudoscopic, i.e., a frame misalignment condition. The interframe indicia are projected in this latter case by the upper lens. At this point, the projection system should be reframed.

Other modifications to process 800 may include blocking the lower projection lens 137 instead of the upper projection lens in step 802. For this modification, step 803 would continue by looking for the projection of the gap indicia on lower port mask 162 and/or below screen 140.

It will be appreciated that the present invention provides a method for monitoring, determining, and correcting the framing status of the projection of stereoscopic 3D film, so that corrective action can be undertaken, as needed. Such a method is intended to be performed on a film having a series of right-eye and left-eye images intended for stereoscopic presentation. The film can include different indicia configurations such as at least one of intraframe gap indicia and interframe gap indicia, i.e., only intraframe gap indicia, only interframe gap indicia, or both intraframe and interframe gap indicia. The gap indicia can be provided with some of the frames, and they do not have to be present for all frames. Indicia are provided in a plurality of at least one type of gap (interframe and/or intraframe gap) on the film, and in general, providing indicia in a larger number of gaps would make it easier to detect the presence or absence of projected indicia. Although it is possible, in principle, to determine frame alignment status by using only a single indicium in a single gap (e.g., by manually or slowly advancing the film and detecting the presence or absence of the projected indicium), it is not an efficient way of determining frame alignment status.

One or more steps or procedures in the method can be performed manually or automatically, such as by a processor executing program instructions for implementing one or more of these steps, or by a combination of both. Automated steps can be performed in a manner substantially similar to the steps discussed above in other examples. When a sensor or detector is used to directly view the presence or absence of gap indicia in the film gate, there is no need to actually project the images for determining the framing status.

A system and a computer readable medium are also provided for implementing the method of the present invention. For example, the system may include one or more processors, memory devices and so on, and the computer readable medium may be programmed to contain instructions for implementing various steps related to the method of the present invention. The computer readable medium may include a hard drive, removable storage, read-only memory, random accessible memory, and the like, which includes program instructions stored thereon. These instruction, when executed by one or more processors, can implement one or more steps of a method as discussed above. It will be appreciated that the one or more processors can be an integral part of the projection system, or can be provided separately from and as an adjunct to the projection system.

It will be understood that the indicating marks taught herein can be written onto the film at various stages in the film production process. Obviously, a camera recorder can be adapted to write each type of indicating mark. Furthermore, during the production of a conformed negative, each indicating mark could also be written onto the film. Other stages in film production may also be more or less adaptable to the writing of these indicating marks. Writing techniques are well known in the art and are not described herein.

All examples and conditional language recited herein are intended to aid the reader in understanding the present principles, and are to be construed as being without limitation to such specifically recited examples and conditions.

Moreover, all statements herein reciting principles, aspects, and embodiments of the present invention, as well as specific examples thereof, are intended to encompass both structural and functional equivalents thereof. It is intended that such equivalents include both currently known equivalents as well as equivalents developed in the future, including any elements developed at any that perform the same function, regardless of structure.

A number of implementations have been described herein. Nevertheless, it will be understood that various modifications may be made. For example, one or more elements of different implementations may be combined, supplemented, modified, or removed to produce other implementations. Additionally, other structures and processes may be substituted for those disclosed and the resulting implementations will perform at least substantially the same function(s), in at least substantially the same way(s), to achieve at least substantially the same result(s) as the implementations disclosed. In particular, although illustrative embodiments have been described herein with reference to the accompanying drawings, it is to be understood that the present principles are not limited to those precise embodiments, and that various changes and modifications may be effected therein by one of ordinary skill in the pertinent art without departing from the scope or spirit of the present principles. Accordingly, these and other implementations are contemplated by this application and are within the scope of the following claims.

What is claimed is:

1. A method for use in a three-dimensional (3D) film projection system, comprising:
projecting a film having a plurality of stereoscopic image pairs, the film including a first gap indicium positioned in a first gap between consecutive images in at least a first subset of the plurality of stereoscopic image pairs, wherein the first gap is selected from a group including an interframe gap and an intraframe gap;
detecting for a presence of at least one of: the first gap indicium and a projection thereof; and
determining a stereoscopic frame alignment status for the stereoscopic image pairs based on result of the detection.

2. The method of claim 1, further comprising:
indicating a stereoscopic frame misalignment condition when the presence is not detected.

3. The method of claim 1, further comprising:
indicating a stereoscopic frame alignment condition when the presence of at least one of the first gap indicium and a projection thereof is detected.

4. The method according to claim 2, further comprising:
correcting the frame misalignment condition for stereoscopic image pairs to achieve a stereoscopic frame alignment condition.

5. The method according to claim 1, wherein the film also includes a second gap indicium positioned in a second gap between consecutive images in at least a second subset of the plurality of stereoscopic image pairs, wherein the second gap is selected from the group including an interframe gap and an intraframe gap, and wherein the second gap is different from the first gap, the method further comprising:
detecting for a presence of at least one of: the second gap indicium and a projection thereof; and
indicating a frame misalignment condition for the stereoscopic image pairs, when the presence of at least one of the second gap indicium and the projection thereof is detected.

6. The method according to claim 5, further comprising:
indicating a frame alignment condition for the stereoscopic image pairs, when the presence of at least one of the first gap indicium and the projection thereof is detected.

7. The method according to claim 5, further comprising:
indicating a frame alignment condition for the stereoscopic image pairs, when the presence of at least one of the second gap indicium and the projection thereof is not detected.

8. The method according to claim 5, further comprising:
correcting the frame misalignment condition for stereoscopic image pairs to achieve a stereoscopic frame alignment condition.

9. The method according to claim 5 wherein second gap indicium exhibits one or more discernibly different characteristics from the first gap indicium.

10. The method according to claim 9, wherein the one or more discernibly different characteristics includes: size, color, shape, number of components, position, animation, and patterns.

11. The method according to claim 1, wherein the 3D film projection system includes two lenses for projecting respective left-eye and right-eye images of the stereoscopic image pairs, and the detecting is performed while preventing image projection through one of the two lenses.

12. The method according to claim 5, wherein the 3D film projection system includes two lenses for projecting respective left-eye and right-eye images of the stereoscopic image pairs, and the detecting is performed while preventing image projection through one of the two lenses.

13. The method of claim 1, wherein the detecting of the presence of the first gap indicium is performed with an automated sensor monitoring a portion of the film at a film gate of the projection system.

14. The method of claim 1, wherein the detecting of the presence of the projection of the first gap indicium is performed by monitoring an area outside of a screen used for projecting the plurality of stereoscopic image pairs.

15. A method for producing a film, the film comprising a plurality of pairs of stereoscopic images arranged in sequential order, wherein an inter-frame gap is formed between two adjacent images from different consecutive pairs of stereoscopic images, and wherein an intra-frame gap is formed between two adjacent images from a same pair of stereoscopic images, the method comprising:
writing a first gap indicium to the film within the intra-frame gap, the first gap indicium for identifying a frame alignment condition when the first gap indicium is detected upon being subjected to projection; and
writing a second gap indicium to the film within the inter-frame gap, the second gap indicium for identifying a frame misalignment condition when the second gap indicium is detected upon being subjected to projection;
wherein the second gap indicium exhibits one or more discernibly different properties from the first gap indicium.

16. A film comprising:
a plurality of stereoscopic image pairs of first and second images arranged in sequential order;
a first gap indicium positioned substantially within an intra-frame gap formed between first and second adjacent images from a same stereoscopic image pair; and
the first gap indicium for identifying a frame alignment condition when the first gap indicium is detected upon being subjected to projection.

17. The film according to claim 16, further comprising:
a second gap indicium positioned substantially within an inter-frame gap formed between first and second adjacent images from different stereoscopic image pairs, wherein the second gap indicia exhibits one or more discernibly different properties from the first gap indicia; and
the second gap indicium for identifying a frame misalignment condition when the second gap indicium is detected upon being subjected to projection.

18. The film according to claim 17, wherein the one or more discernibly different characteristics includes: size, color, shape, number of components, position, animation, and patterns.

19. A projection apparatus, comprising:
means for projecting a film having a plurality of stereoscopic image pairs, the film including a first gap indicium positioned in a first gap between consecutive images in at least a first subset of the plurality of stereoscopic image pairs, wherein the first gap is selected from a group including an interframe gap and an intraframe gap;
means for detecting a presence of at least one of: the first gap indicium and a projection thereof; and
at least one of: means for indicating a frame misalignment condition for the stereoscopic image pairs, when the presence is not detected; and means for indicating a frame alignment condition for the stereoscopic image pairs, when the presence of at least one of the first gap indicium and a projection thereof is detected.

20. The apparatus according to claim 19, further comprising:
means for correcting the frame misalignment condition for stereoscopic image pairs to achieve a stereoscopic frame alignment condition.

21. The apparatus according to claim 19, wherein the film also includes a second gap indicium positioned in a second gap between consecutive images in at least a second subset of the plurality of stereoscopic image pairs, wherein the second gap is selected from the group including an interframe gap and an intraframe gap, and wherein the second gap is different from the first gap, the apparatus further comprising:
means for detecting a presence of at least one of: the second gap indicium and a projection thereof; and
at least one of: means for indicating a frame misalignment condition for the stereoscopic image pairs, when the presence of at least one of the second gap indicium and the projection thereof is detected; and means for indicating a frame alignment condition for the stereoscopic image pairs, when the presence of at least one of the second gap indicium and the projection thereof is not detected.

22. The apparatus according to claim 21, further comprising:
means for adjusting the frame misalignment condition for stereoscopic image pairs to achieve a stereoscopic frame alignment condition.

23. The apparatus according to claim 21 wherein second gap indicium exhibits one or more discernibly different characteristics from the first gap indicium.

24. The apparatus according to claim 23, wherein the one or more discernibly different characteristics includes: size, color, shape, number of components, position, animation, and patterns.
